(19) United States
(12) Patent Application Publication
(10) Pub. No.: US 2015/0215363 A1
(43) Pub. Date: Jul. 30, 2015

(54) Network Speed Indication Method And Mobile Device Using The Same

(71) Applicant: Tencent Technology (Shenzhen) Company Limited, Shenzhen (CN)

(72) Inventors: Yinghua YE, Shenzhen (CN); Ximin YU, Shenzhen (CN)

(21) Appl. No.: 14/679,633

(22) Filed: Apr. 6, 2015

Related U.S. Application Data
(63) Continuation of application No. PCT/CN2013/079147, filed on Jul. 10, 2013.

(30) Foreign Application Priority Data
Oct. 18, 2012 (CN) 201210398029.0

(51) Int. Cl. H04L 29/06; H04L 12/24

(52) U.S. Cl. CPC H04L 65/604; H04L 41/22

(57) ABSTRACT

A network speed indication method and a mobile device using the same are disclosed. The method performed by the mobile device includes: establishing a data communication connection with a wireless network; detecting a data downloading speed when a currently running application receives data from the wireless network and renders the data on a user interface of the currently running application; obtaining, according to the detected data downloading speed, a speed indicator corresponding to the data downloading speed, so as to update the user interface of the currently running application; updating the user interface of the currently running application in accordance with the speed indicator corresponding to the data downloading speed, so that a user learns of the data downloading speed according to the update user interface; after receiving an application switch request from a user of the mobile device, acquiring, from the wireless network, application content that is suitable for the data downloading speed.

### CROSS-REFERENCE TO RELATED APPLICATIONS

This application is a continuation application of PCT Patent Application No. PCT/CN2013/079147, entitled “NETWORK SPEED INDICATION METHOD AND MOBILE DEVICE” (also translated as “METHOD FOR PROMPTING NETWORK SPEED AND MOBILE DEVICE”), filed on Jul. 10, 2013, which claims priority to Chinese Patent Application No. 201210398029.0, entitled “NETWORK SPEED INDICATION METHOD AND MOBILE DEVICE” filed on Oct. 18, 2012, which is incorporated by reference in its entirety.

### FIELD OF THE TECHNOLOGY

The present disclosure relates to the field of user interface technologies, and in particular, to a network speed indication method and a mobile device.

### BACKGROUND OF THE DISCLOSURE

With the development of wireless communication technologies, for example, a Wireless Fidelity (WiFi) technology and a 2G (second-generation mobile communication)/3G (third-generation mobile communication) technology, a user may access a network in a wireless access manner and acquire information from the network, so that implementation of information acquisition by a user from a network is not limited to network cabling any longer, which greatly facilitates work and life of people.

However, a network environment of a wireless network is unstable. When a user cannot clearly learn of a current data transmission speed of a wireless network, a data loss or an error may occur when the user receives data from the wireless network. In the existing technology, the following manner is used to indicate a speed at which data is received from a wireless network to a user: Speeds at which a user receives data from a wireless network are divided into levels, a different data downloading speed is mapped to a different number of signal bars, and the number of signal bars is displayed at the top right corner of a user interface of a mobile device, so that a user may learn of, according to the number of displayed signal bars, a speed at which data is received from a wireless network currently.

However, the existing technology at least has the following problems: When a user displays acquired network content in full screen, the number of currently displayed signal bars cannot be displayed, so that when the network content is displayed in a browser in full screen, the user cannot learn about a speed at which data can be received from a wireless network currently.

### SUMMARY

According to an aspect, an embodiment of the present disclosure provides a network speed indication method performed at a mobile device having one or more processors and memory for storing one or more programs to be executed by the one or more processors, the method including:

establishing a data communication connection with a wireless network;

detecting a data downloading speed at which the currently running application receives data from the wireless network and renders the data on a user interface of the application and renders the data on a user interface of the currently running application;

obtaining, according to the detected data downloading speed, a speed indicator corresponding to the data downloading speed, so as to update the user interface of the currently running application;

updating the user interface of the currently running application in accordance with the speed indicator corresponding to the data downloading speed, so that a user learns of the data downloading speed according to the update user interface; and

after receiving an application switch request from a user of the mobile device, acquiring, from the wireless network, application content that is suitable for the data downloading speed.

According to another aspect, an embodiment of the present disclosure provides a mobile device having one or more processors, memory, and one or more program modules stored in the memory and to be executed by the one or more processors, the one or more program modules further comprising:

a detection module, configured to detect a data downloading speed when a currently running application receives data from a wireless network and renders the data on a user interface of the currently running application;

a processing module, configured to obtain, according to the detected data downloading speed, a speed indicator corresponding to the data downloading speed, so as to update the user interface of the currently running application;

a display module, configured to update the user interface of the currently running application in accordance with the speed indicator corresponding to the data downloading speed, so that a user learns of the data downloading speed according to the update user interface; and

an application switch module, configured to acquire, from the wireless network, application content that is suitable for the data downloading speed after receiving an application switch request from a user of the mobile device.

### BRIEF DESCRIPTION OF THE DRAWINGS

To describe the technical solutions of the embodiments of the present disclosure more clearly, the accompanying drawings for illustrating the embodiments will be introduced briefly in the following. Apparently, the accompanying drawings in the following description are only some embodiments of the present disclosure, and a person of ordinary skill in the art may obtain other drawings based on these accompanying drawings without creative efforts.

FIG. 1 is a flowchart of a network speed indication method provided in Embodiment 1 of the present disclosure;

FIG. 2 is a flowchart of a network speed indication method provided in Embodiment 2 of the present disclosure;

FIG. 3 is a schematic structural diagram of a mobile device provided in Embodiment 3 of the present disclosure;

FIG. 4 is a schematic structural diagram of a mobile device provided in Embodiment 3 of the present disclosure;

FIG. 5 is a schematic structural diagram of a mobile device provided in Embodiment 3 of the present disclosure; and

FIG. 6 is a schematic structural diagram of a mobile device provided in Embodiment 3 of the present disclosure.

### DESCRIPTION OF EMBODIMENTS

To make the objectives, technical solutions, and advantages of the present disclosure clearer, the following further describes the implementation manners in the present disclosure in detail with reference to the accompanying drawings.

According to each embodiment, a mobile terminal that may be used as an example includes, but is not limited to, a tablet computer (the tablet computer includes, but is not limited to, an Apple iPad and another touchscreen device running an Apple iOS, a Microsoft Surface and another touchscreen device running a Windows operating system, and another tablet device running an Android operating system), a mobile phone, a smart phone (the smart phone includes, but is not limited to, an Apple iPhone, a Windows phone, another smart phone running a Windows Mobile or Pocket PC operating system, and a smart phone running an Android operating system, a Blackberry operating system, or a Symbian operating system), an e-reader (the e-reader includes, but is not limited to, an Amazon Kindle and a Barnes & Noble Nook), a portable computer (the portable computer includes, but is not limited to, a computer running an Apple Mac operating system, a Windows operating system, an Android operating system and/or a Google Chrome operating system), or an on-board device running any of the foregoing operating systems or any of other operating systems. The foregoing examples of a mobile terminal are all common knowledge of a person skilled in the art.

### Embodiment 1

This embodiment provides a network speed indication method, including:

Step 101: A mobile device detects a data downloading speed when a currently running application receives data from a wireless network and renders the data on a user interface of the currently running application.

Step 102: The mobile device obtains, according to the detected data downloading speed, a speed indicator corresponding to the data downloading speed, so as to update the user interface of the currently running application.

Step 103: The mobile device updates the user interface of the currently running application in accordance with the speed indicator corresponding to the data downloading speed, so that a user learns of the data downloading speed according to the update user interface.

According to the foregoing technical solution, a mobile device updates, according to a detected data downloading speed when data is received from a wireless network, a user interface of a currently running application, and includes a speed indicator corresponding to the data downloading speed in the user interface, so that a speed at which data is received from the wireless network currently is indicated to a user. The indication manner is diversified and intuitive and a problem that a speed at which data is received from a network cannot be indicated in full screen in the existing technology can be overcome.

### Embodiment 2

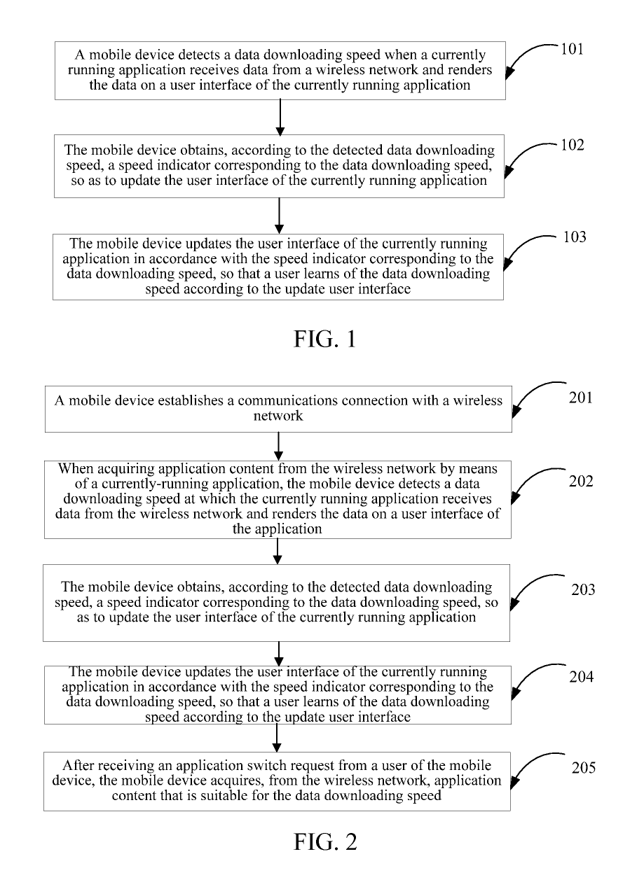

The following describes the technical solution shown in FIG. 1 in detail with reference to a specific embodiment. Referring to FIG. 2, a network speed indication method is shown. The method may specifically be implemented by a mobile device such as a computer, a mobile phone or a tablet computer, and further the method may be implemented by an application built in a mobile device such as a computer, a mobile phone or a tablet computer, and includes the following operations:

Step 201: A mobile device establishes a data communications connection with a wireless network.

Specifically, the mobile device may be connected to the wireless network by using a wireless Access Point (AP) and establishes the communications connection with the wireless network, or the mobile device may be connected to the wireless network by using an access base station to establish the communications connection with the wireless network. Therefore, after the communications connection is established between the mobile device and the wireless network, the mobile device may request to acquire needed data information from the wireless network by means of an application, for example, a browser built in the mobile device.

Step 202: When acquiring application content from the wireless network by means of a currently-running application, the mobile device detects a data downloading speed at which the currently running application receives data from the wireless network and renders the data on a user interface of the application, where the application content includes a video, audio, a text, or a web page.

For details about a manner of detecting the data downloading speed when data is received from the wireless network, reference may be made to related description in the existing technology, which is not further described herein.

Step 203: The mobile device obtains, according to the detected data downloading speed, a speed indicator corresponding to the data downloading speed, so as to update the user interface of the currently running application.

Specifically, according to a correspondence between the data downloading speed and the indication pattern, an indication pattern corresponding to the data downloading speed is obtained, where the indication pattern specifically includes a display background, a display skin, or a display theme; and the obtained indication pattern is added to the user interface, so as to obtain a speed indicator corresponding to the data downloading speed.

That the obtained indication pattern is added to the user interface, so as to obtain a speed indicator corresponding to the data downloading speed may include:

when the obtained indication pattern is a display background, setting a background of the user interface with the obtained display background, so as to obtain the speed indicator corresponding to the data downloading speed;

when the obtained indication pattern is a display theme, setting a theme of the user interface to the obtained display theme, so as to obtain the speed indicator corresponding to the data downloading speed; or

when the obtained indication pattern is a display skin, setting a skin of the user interface to the obtained display skin, so as to obtain the speed indicator corresponding to the data downloading speed.

In this embodiment, a correspondence between a speed and an indication pattern may be shown as Table 1, Table 2, or Table 3.

TABLE 1

| Speed | Indication pattern (background) |
|---|---|
| Above 60 Kb/s | Green background |
| 60 Kb/s to 30 Kb/s | Blue background |
| Below 60 Kb/s | Yellow background |

TABLE 2

| Speed | Indication pattern (theme) |
|---|---|
| Above 60 Kb/s | Theme with a video icon |
| 60 Kb/s to 30 Kb/s | Theme with an audio icon |
| Below 60 Kb/s | Theme with a text file icon |

TABLE 3

| Speed | Indication pattern (skin) |
|---|---|
| Above 60 Kb/s | Skin with a video icon |
| 60 Kb/s to 30 Kb/s | Skin with an audio icon |
| Below 60 Kb/s | Skin with a text file icon |

For example, when it is detected that a speed at which data is received from a wireless network is 70 Kb/s, if a used indication pattern is a display background, it can be found from Table 1 that, an indication pattern corresponding to the speed of 70 Kb/s is a green background and then, a user interface is filled with the green background. In this way, after the display interface with the specific green background is displayed to a user, the user may know that the speed at which data is received from the wireless network currently is above 60 Kb/s.

When it is detected that a speed at which data is received from a wireless network is 40 Kb/s, if a used indication pattern is a display theme, it can be found from Table 2 that, an indication pattern corresponding to the speed of 40 Kb/s is a theme with an audio icon and then, a user interface is set to the theme with an audio icon. In this way, after the display interface with the theme with an audio icon is displayed to a user, the user may know that the speed at which data is received from the wireless network currently is 60 Kb/s to 30 Kb/s.

When it is detected that a speed at which data is received from a wireless network is 20 Kb/s, if a used indication pattern is a display skin, it can be found from Table 3 that, an indication pattern corresponding to the speed of 20 Kb/s is a skin with a text file icon and then, a user interface is set to the skin with a text file icon. In this way, after the display interface with the skin with a text file icon is displayed to a user, the user may know that the speed at which data is received from the wireless network currently is below 30 Kb/s.

Step 204: The mobile device updates the user interface of the currently running application in accordance with the speed indicator corresponding to the data downloading speed, so that a user learns of the data downloading speed according to the update user interface.

Further, in this embodiment of the present disclosure, when the speed indicator corresponding to the data downloading speed is presented in the mobile device, the indication pattern or a character is set in the speed indicator corresponding to the data downloading speed to indicate, to a user, application content that is suitable to be acquired from the wireless network at the data downloading speed.

Generally, when the data downloading speed is above 60 Kb/s, the mobile device may smoothly acquire any application content including a video from the wireless network. When the data downloading speed is 60 Kb/s to 30 Kb/s, the mobile device may smoothly acquire any application content except a video from the wireless network. When the data downloading speed is below 30 Kb/s, the mobile device is not suitable to acquire audio or a video from the wireless network.

In this way, after learning of the data downloading speed according to the update user interface in the mobile device, the user may determine whether to switch currently displayed application content according to the data downloading speed, so that the user may switch, at any time according to the known data downloading speed, to the application content that is suitable for the data downloading speed, which can improve user experience.

Based on the above descriptions, when a user learns, by a update user interface in a mobile device, that a speed at which data is received from a wireless network currently is below 30 Kb/s, but application content being currently acquired from the wireless network by the mobile device is a video, the user may know that, at a current data downloading speed, to continue with acquisition of the video from the wireless network, the time for downloading the video will become excessively long or even a case of a data loss may occur. Therefore, the user may switch from an application that currently acquires the video from the wireless network to a text application or a web page application that is suitable for the data downloading speed.

Step 205: After receiving an application switch request from a user of the mobile device, the mobile device acquires, from the wireless network, application content that is suitable for the data downloading speed.

It can be understood that, step 205 is optional in the network speed indication method according to this embodiment, and the step described herein is merely a possible subsequent processing step after the network speed indication method is used. For example, a user of the mobile device may be watching a video on the mobile device streamed down from the wireless network. The video stored at the source may have different versions corresponding to different resolutions. The user can switch to a video of higher resolution if the speed indicator suggests that the current data downloading speed supports downloading the video of higher resolution at the rate that is required for watching the video smoothly on the mobile device. Alternatively, the user can also switch to a video of lower resolution if the speed indicator suggests that the current data downloading speed has dropped such that it no longer supports downloading the video of higher resolution but can still support downloading the video of lower resolution at the rate that is required for watching the video smoothly on the mobile device. In other words, the existence of the speed indicator provides the user a choice of finding a compromise between the data downloading speed and the user experience of watching the downloaded data. This is particularly important when the wireless network's bandwidth is limited and the user may prefer a smooth experience of watching the video within a short time period over watching a high definition video at the price of frequent stops due to the limit of data downloading speed available to the mobile device.

According to the foregoing technical solution, a mobile device updates, according to a detected data downloading speed when data is received from a wireless network, a user interface of a currently running application, and includes a speed indicator corresponding to the data downloading speed in the user interface, so that a speed at which data is received from the wireless network currently is indicated to a user. An indication manner is diversified and intuitive and a problem that a speed at which data is received from a network cannot be indicated in full screen in the existing technology can be overcome.

### Embodiment 3

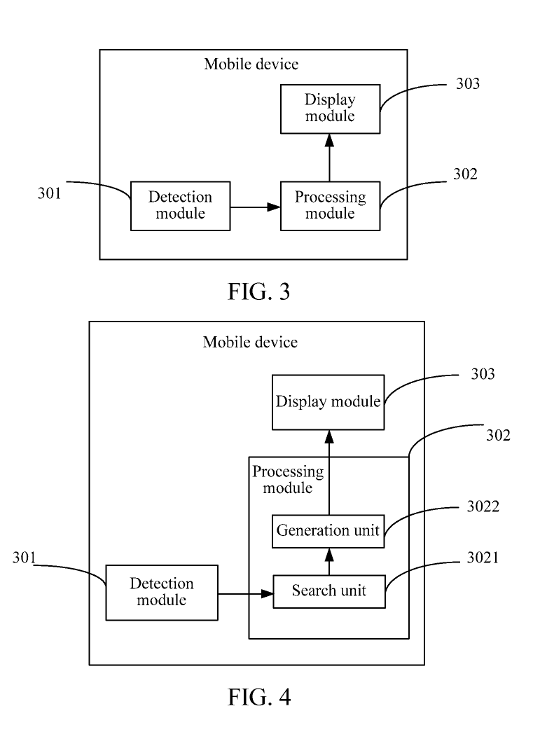

Referring to FIG. 3, this embodiment provides a mobile device. The mobile device includes a detection module 301, a processing module 302, and a display module 303.

The detection module 301 is configured to detect a data downloading speed when a currently running application receives data from a wireless network and renders the data on a user interface of the currently running application.

The processing module 302 is configured to obtain, according to the detected data downloading speed, a speed indicator corresponding to the data downloading speed, so as to update the user interface of the currently running application.

The display module 303 is configured to update the user interface of the currently running application in accordance with the speed indicator corresponding to the data downloading speed, so that a user learns of the data downloading speed according to the update user interface.

Further, referring to FIG. 4, in this embodiment, the processing module 302 shown in FIG. 3 includes:

a search unit 3021, configured to obtain an indication pattern corresponding to the data downloading speed according to a correspondence between the data downloading speed and the indication pattern; and

a generation unit 3022, configured to add the obtained indication pattern to the user interface, so as to obtain a speed indicator corresponding to the data downloading speed.

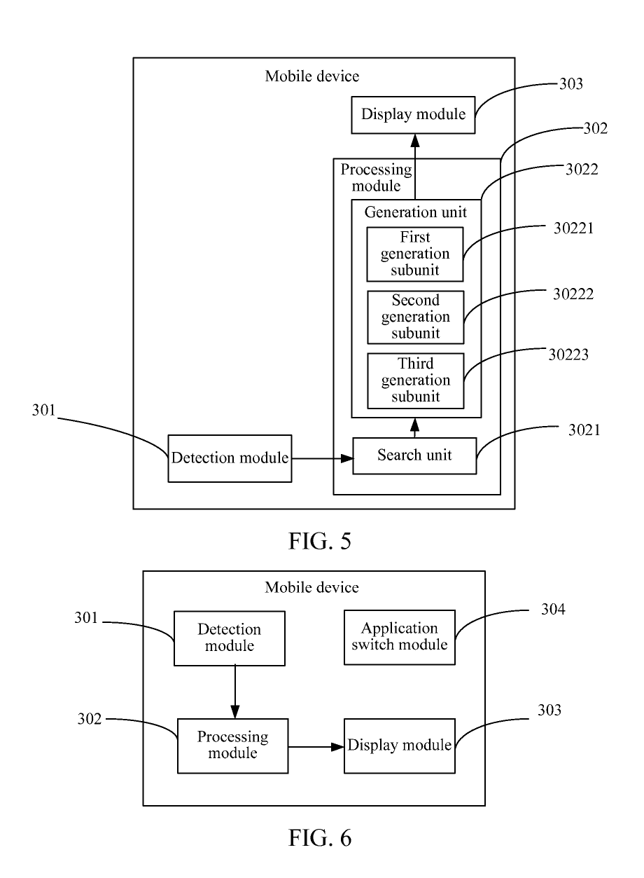

Further, referring to FIG. 5, in this embodiment, the generation unit 3022 shown in FIG. 4 includes:

a first generation subunit 30221, configured to set a background of the user interface with the obtained display background, so as to obtain the speed indicator corresponding to the data downloading speed, when the obtained indication pattern is a display background;

a second generation subunit 30222, configured to set a theme of the user interface to the obtained display theme, so as to obtain the speed indicator corresponding to the data downloading speed, when the obtained indication pattern is a display theme; and

a third generation subunit 30223, configured to set a skin of the user interface to the obtained display skin, so as to obtain the speed indicator corresponding to the data downloading speed, when the obtained indication pattern is the display skin.

Further, referring to FIG. 6, in this embodiment, the mobile device shown in FIG. 3 may further include:

an application switch module 304, configured to acquire, from the wireless network, application content that is suitable for the data downloading speed after receiving an application switch request from a user of the mobile device.

During specific implementation, in this embodiment, the mobile device shown in FIG. 3 may further include:

a wireless connection module, configured to establish, before the mobile device acquires application content from the wireless network by means of a currently-running application, a communications connection with the wireless network.

According to the foregoing technical solution, a mobile device updates, according to a detected data downloading speed when data is received from a wireless network, a current user interface, and includes a speed indicator corresponding to the data downloading speed in the user interface, so that a speed at which data is received from the wireless network currently is indicated to a user. An indication manner is diversified and intuitive and a problem that a speed at which data is received from a network cannot be indicated in full screen in the existing technology can be overcome.

It should be noted that when the mobile device provided in the foregoing embodiments indicates a network speed, the foregoing division of functional modules is only used as an example for description. In practical applications, the foregoing functions may be allocated to be accomplished by different functional modules according to needs, that is, the internal structure of the mobile device is divided into different functional modules to accomplish all or some of the functions described above. In addition, the mobile device for indicating a network speed provided in the foregoing embodiments share the same concept with the embodiments of the network speed indication method, and reference may be made to the method embodiments for the specific implementation process of the apparatus, which is no longer elaborated herein.

The sequence numbers of the foregoing embodiments of the present disclosure are merely for description, and do not imply the preference among the embodiments.

In the embodiments of the present invention, the mobile device according to the embodiment of the present invention can be constructed and the network speed indication method according to the embodiment of the present invention can be implemented by running a computer program (the computer program includes program code) capable of implementing the network speed indication method according to the embodiment of the present invention, where the computer program is run in a general computer device, for example, a computer, and includes processing elements and non-transitory computer-readable storage medium such as a central processing unit (CPU), a random access memory (RAM), and a read-only memory (ROM). The computer program may be recorded in, for example, a computer readable recording medium and may be loaded, by the computer readable recording medium, and run in the foregoing computing device.

The foregoing descriptions are merely preferred embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A network speed indication method, comprising:
at a mobile device having one or more processors and memory for storing one or more programs to be executed by the one or more processors:
establishing a data communication connection with a wireless network;
detecting a data downloading speed at which the currently running application receives data from the wireless network and renders the data on a user interface of the application and renders the data on a user interface of the currently running application;
obtaining, according to the detected data downloading speed, a speed indicator corresponding to the data downloading speed, so as to update the user interface of the currently running application;
updating the user interface of the currently running application in accordance with the speed indicator corresponding to the data downloading speed, so that a user learns of the data downloading speed according to the update user interface; and
after receiving an application switch request from a user of the mobile device, acquiring, from the wireless network, application content that is suitable for the data downloading speed.

2. The method according to claim 1, wherein the obtaining step further comprises:
obtaining an indication pattern corresponding to the data downloading speed according to a correspondence between the data downloading speed and the indication pattern; and
adding the obtained indication pattern to the user interface, so as to obtain a speed indicator corresponding to the data downloading speed.

3. The method according to claim 2, wherein the adding step further comprises:
when the obtained indication pattern is a display background, setting a background of the user interface with the obtained display background, so as to obtain the speed indicator corresponding to the data downloading speed;
when the obtained indication pattern is a display theme, setting a theme of the user interface to the obtained display theme, so as to obtain the speed indicator corresponding to the data downloading speed; or
when the obtained indication pattern is a display skin, setting a skin of the user interface to the obtained display skin, so as to obtain the speed indicator corresponding to the data downloading speed.

4. The method according to claim 2, further comprising:
setting the indication pattern or a character in the speed indicator corresponding to the data downloading speed to indicate, to a user, application content that is suitable to be acquired from the wireless network at the data downloading speed.

5. A mobile device having one or more processors, memory, and one or more program modules stored in the memory and to be executed by the one or more processors, the one or more program modules further comprising:
a detection module, configured to detect a data downloading speed when a currently running application receives data from a wireless network and renders the data on a user interface of the currently running application;
a processing module, configured to obtain, according to the detected data downloading speed, a speed indicator corresponding to the data downloading speed, so as to update the user interface of the currently running application;
a display module, configured to update the user interface of the currently running application in accordance with the speed indicator corresponding to the data downloading speed, so that a user learns of the data downloading speed according to the update user interface; and
an application switch module, configured to acquire, from the wireless network, application content that is suitable for the data downloading speed after receiving an application switch request from a user of the mobile device.

6. The mobile device according to claim 5, wherein the processing module further comprises:
a search unit, configured to obtain an indication pattern corresponding to the data downloading speed according to a correspondence between the data downloading speed and the indication pattern; and
a generation unit, configured to add the obtained indication pattern to the user interface, so as to obtain a speed indicator corresponding to the data downloading speed.

7. The mobile device according to claim 6, wherein the generation unit further comprises:
a first generation subunit, configured to set a background of the user interface with the obtained display background, so as to obtain the speed indicator corresponding to the data downloading speed, when the obtained indication pattern is a display background;
a second generation subunit, configured to set a theme of the user interface to the obtained display theme, so as to obtain the speed indicator corresponding to the data downloading speed, when the obtained indication pattern is a display theme; and
a third generation subunit, configured to set a skin of the user interface to the obtained display skin, so as to obtain the speed indicator corresponding to the data downloading speed, when the obtained indication pattern is the display skin.

8. The mobile device according to claim 7, wherein the processing module is further specifically configured to set the indication pattern or a character in the speed indicator corresponding to the data downloading speed to indicate, to a user, application content that is suitable to be acquired from the wireless network at the data downloading speed.

9. A non-transitory computer readable storage medium having stored therein one or more programs for execution by a mobile device having one or more processors and a display, the one or more programs further including:
a detection module, configured to detect a data downloading speed when a currently running application receives data from a wireless network and renders the data on a user interface of the currently running application;
a processing module, configured to obtain, according to the detected data downloading speed, a speed indicator corresponding to the data downloading speed, so as to update the user interface of the currently running application;
a display module, configured to update the user interface of the currently running application in accordance with the speed indicator corresponding to the data downloading speed, so that a user learns of the data downloading speed according to the update user interface; and
an application switch module, configured to acquire, from the wireless network, application content that is suitable for the data downloading speed after receiving an application switch request from a user of the mobile device.

10. The non-transitory computer readable storage medium according to claim 9, wherein the processing module further comprises:
a search unit, configured to obtain an indication pattern corresponding to the data downloading speed according to a correspondence between the data downloading speed and the indication pattern; and
a generation unit, configured to add the obtained indication pattern to the user interface, so as to obtain a speed indicator corresponding to the data downloading speed.

11. The non-transitory computer readable storage medium according to claim 10, wherein the generation unit further comprises:
a first generation subunit, configured to set a background of the user interface with the obtained display background, so as to obtain the speed indicator corresponding to the data downloading speed, when the obtained indication pattern is a display background;
a second generation subunit, configured to set a theme of the user interface to the obtained display theme, so as to obtain the speed indicator corresponding to the data downloading speed, when the obtained indication pattern is a display theme; and
a third generation subunit, configured to set a skin of the user interface to the obtained display skin, so as to obtain the speed indicator corresponding to the data downloading speed, when the obtained indication pattern is the display skin.

12. The non-transitory computer readable storage medium according to claim 11, wherein the processing module is further specifically configured to set the indication pattern or a character in the speed indicator corresponding to the data downloading speed to indicate, to a user, application content that is suitable to be acquired from the wireless network at the data downloading speed.
